(19) United States
(12) Patent Application Publication
(10) Pub. No.: US 2025/0019080 A1
(43) Pub. Date: Jan. 16, 2025

(54) SYSTEM INCLUDING AT LEAST ONE EJECTABLE SAFETY POD FOR PROTECTING OCCUPANTS OF A VEHICLE DURING AND AFTER A CATASTROPHIC EVENT

(71) Applicant: Roy Bey, Hampton, VA (US)

(72) Inventor: Roy Bey, Hampton, VA (US)

(21) Appl. No.: 18/375,587

(22) Filed: Oct. 2, 2023

Related U.S. Application Data
(60) Provisional application No. 63/628,305, filed on Jul. 12, 2023.

(51) Int. Cl. B64D 25/12; B64D 11/06; B64D 17/80

(52) U.S. Cl. CPC B64D 25/12; B64D 11/06

(57) ABSTRACT

A system for protecting occupants of a vehicle during aa catastrophic event includes at least one safety pod that encloses one or more seats within the vehicle. The pod is constructed of a material that is fire proof, waterproof, bomb proof, crash proof, and/or capable of withstanding any other physical or environmental hazards that might be expected during the catastrophic event, and includes a sliding, electrically powered doors that seals the pod when closed. The pod may be configured to be ejected from the vehicle when the catastrophic event occurs or is imminent. When the vehicle is a passenger airplane, pods may be provided for each row of passenger seats, the pods being mounted to tracks by brackets and latched in a stationary position until an emergency occurs. When an emergency that requires ejection from the airplane occurs, the pods are propelled towards the rear of the airplane, and at least a portion of the rear section of the airplane is detachable to provide a space through which the pods are ejected. Sealing of the pods protects the occupants from hazards such as fire and smoke, and provides a waterproof flotation chamber in case of ejection over water.

### BACKGROUND OF THE INVENTION

This application claims the benefit of provisional U.S. Patent Appl. Ser. No. 63/628,305, filed Jul. 12, 2023, which is incorporated by reference herein.

### 1. Field of the Invention

The present invention relates to a system for protecting occupants of a vehicle during a catastrophic event, such as a crash, collision, fire, or any other event that could endanger occupants of the vehicle or lead to destruction of the vehicle.

The system includes at least one safety pod that surrounds one or more seats in a vehicle while allowing the occupants to enter and leave their respective seats during normal operation of the vehicle. When a catastrophic event occurs or is imminent, the safety pod is closed, sealed and, if possible, ejected from the vehicle, with the occupants still seated in their seats. After ejection, the pod protects the occupants from impacts and, depending on the type of vehicle in which the safety pod was installed, other hazards until emergency responders or rescuers are able to reach the pod.

Vehicles in which the safety pods of the invention may be utilized include airplanes, helicopters, automobiles, trucks, buses, trains, ships, boats and other watercraft, armored vehicles and tanks, and spacecraft.

In an exemplary embodiment, the system of the invention may be used to protect the pilots, crew, and passengers of a commercial airliner during a crash or collision.

### 2. Description of Related Art

Most moving vehicles are subject to events that can lead to injury or death to the occupants of the vehicle. Airplanes crash. Automobiles collide. Trains derail. Space shuttles disintegrate upon reentry. Military vehicles are hit by enemy fire.

The greater the likelihood that a catastrophic event will occur, the more safety features are built into the vehicle. Automobiles, for example, are designed to deflect collision forces away from the occupants of the vehicle, and to include seatbelts and airbags to further protect the occupants. Military vehicles may be armored and aircraft provided with ejection seats. On the other hand, where the probability of an accident is rare, economic considerations may dictate a lower level of protection for occupants of the vehicle. For example, since commercial air travel is statistically very safe, passenger aircraft provide relatively little protection for occupants of the aircraft when a catastrophic even does occur. In that case, injury and death are expected. The seatbelts and under-seat flotation devices on a passenger airplane provide little, if any, protection against crashes, fires, and other catastrophes. A crash involving a passenger aircraft can result in hundreds of deaths. Such deaths are considered to be inevitable—essentially the price to be paid for the convenience of being able to travel to anywhere in the world in just a few hours.

The present invention rejects the view that injury and/or death are inevitable for any vehicle with the potential for a catastrophic event. Instead, the present invention seeks to provide protection, in a practical and economically viable manner, for passengers and operators of any vehicle, including aircraft as well as automobiles, military vehicles, watercraft, and any other vehicle in which occupants might be vulnerable to injury or death from impacts and other hazards, such as fire. Aircraft, helicopters, trains, cars and so forth are all complex systems, and cannot be made completely accident or destruction proof. However, the inventor does not accept the conventional view that injury or death from such accidents is inevitable, and has therefore devised a way to protect the occupants of any vehicle, no matter what happens to the vehicle.

In the case of aircraft, the present invention may be compared with ejection seats provided to the pilots of fighter jets. However, unlike conventional ejection seats, the present invention provides complete protection for the occupant of the seat being ejected, by enclosing the occupant in a cocoon that protects the occupant from impacts and environmental hazards both during and after ejection. While ejection from a fighter aircraft requires operator action and training, the safety pod of the present invention requires no such action on the part of the occupant, and no training. In the event of ejection over land, the safety pod uses impact resistant construction, cushioning and/or padding to protect the occupant during impact with the ground, while in the event of ejection over water, the safety pod also serves as a flotation device.

Even though the safety pod of the invention provides order-of-magnitude better protection for passengers and operators of a vehicle than conventional safety measures, the safety pod nevertheless allows normal operation of the vehicle without inconveniencing either passengers or operators. For example, passengers on an airplane will still be free to leave their seats, visit the restroom, enjoy beverage and meal service, and so forth. While there is a price to adding the safety pods to a conventional vehicle, the cost should not unbearable, and likely will be offset by reduced costs for insurance and medical care, and by the reduced cost of injury or death on individuals, families, and society.

### SUMMARY OF THE INVENTION

It is accordingly a first objective of the present invention to provide a system for protecting an occupant of a vehicle during and after a catastrophic event that would otherwise cause injury or death of the occupant.

It is a second objective of the invention to provide a system for ensuring that the occupant of a vehicle will survive a catastrophic event or accident, including an event that completely destroys the vehicle in which the occupant is a traveling.

It is a third objective of the invention to provide a system for ensuring the safety of vehicle occupants that protects the occupants from impacts and environmental hazards resulting from a catastrophic event, and yet that is economical and can be implemented in a wide variety of vehicles.

It is fourth objective of the invention to provide a device for ejecting occupants of a vehicle from the vehicle during a catastrophic event, and that protects the occupants both during and after ejection.

It is a fifth objective of the invention to provide a safety pod for a commercial airliner, a plurality of which can be retrofitted into an existing fuselage, and that allows a passenger to leave and return to their seats and receive service items during a flight, and yet that completely encloses and protects the passenger during an injury or life threatening emergency.

These objectives are achieved by providing, within a vehicle, a safety pod that encloses one or more seated occupants of the vehicle during a catastrophic event, and yet that does not restrict activities or the freedom of the passenger of the vehicle to move about during non-emergency operation of the vehicle, i.e., when there is no threat of injury or death to the vehicle occupants. When a catastrophic event occurs or is imminent, a door or opening in the safety pod closes to seal the safety pod and protect its occupant (or occupants) during ejection of the safety pod from the vehicle. The pod provides protection for the occupant against hazards such as fire, explosion, and impact with land or water. Preferably, the pod is waterproof and buoyant to provide protection for the occupants while awaiting rescue in case of an emergency over water.

In an exemplary embodiment of the invention, the system of the invention is utilized in a commercial airliner. According to the exemplary embodiment, the airplane is equipped with a plurality of pods that, depending on the seating configuration of the airliner, respectively enclose individual passenger seats or rows of passenger seats, as well as seats in the aircraft cockpit. The pods may be ovoid in shape and constructed of a material that is fire proof, waterproof, bomb proof, crash proof, and/or capable of withstanding any other physical or environmental hazards that might be expected during a catastrophic event. Although the invention is not limited to a specific material, examples of potentially suitable materials that are currently used in applications where strength, weight, and cost are considerations include acrylonitrile butadiene styrene (ABS), which is currently used in automotive parts such as bumpers, high-density polyethylene (HDPE), and polycarbonate (PC), with the addition as necessary of heat and/or water resistant coatings.

In addition to surviving catastrophic events such as crashes, collisions, and fires, the safety pods of the preferred embodiments may optionally, when utilized in especially critical vehicles such as Air Force 1, be constructed to survive the blast and electromagnetic pulse from a nuclear explosion, utilizing technology described in https://qz.com/527421/an-upgraded-air-force-one-could-dodge-heat-seeking-missiles.

In the exemplary embodiments, the safety pods include sliding, electrically powered doors that seal the safety pod when closed. The pods are mounted to tracks by brackets and latched or held in a stationary position until an emergency occurs. When an emergency that requires ejection from the airplane occurs, the pods are propelled towards the rear of the airplane. At least a portion of the rear section of the airplane is detachable to provide an opening or space through which the pods are ejected. Sealing of the pods protects the occupants from hazards such as fire and smoke, and provides a waterproof flotation chamber in case of ejection over water.

Preferably, in the exemplary embodiments, the interior of the pods are well-padded to protect the occupant from impacts between the occupant and walls of the pod. Sealing of the pods also prevents loss of pressure upon ejection from the airplane, although it is possible to include an air supply to maintain or establish pressure if aircraft cabin pressure is lost before the door is closed and the pod sealed.

Also in the exemplary embodiments, the safety pods may each include such additional features or amenities as storage for emergency supplies, a display screen to enable the occupant to view conditions outside the pod, seat belts and/or safety harnesses, a battery and/or solar electrical supply, and a beacon or emergency transmitter to enable rescuers to locate the pod after ejection.

### BRIEF DESCRIPTION OF THE DRAWINGS

FIG. 1 is a plan view of an airplane outfitted with safety pods according to an exemplary embodiment of the present invention.

FIG. 2 is a front elevation of a safety pod and seating arrangement that may be used in the exemplary embodiment of FIG. 1.

FIG. 3 is an isometric view of the exterior of a safety pod that may be used in the exemplary embodiment of FIG. 1.

FIG. 4 is an isometric view of an ejection track for use with the safety pods of the exemplary embodiment.

FIG. 5 is a cut-away side view showing an interior of the pod of FIG. 3.

FIG. 6 is a partially cut-away top view showing the track locations for the exemplary embodiment of FIG. 1.

FIG. 7 is a side view shows the location of a cabin pod for the airplane of the exemplary embodiment.

FIG. 8 is a front view of the airplane of FIG. 7.

FIG. 9 is an alternative plan view of the airplane of FIG. 1.

FIG. 10 is a side view of the exterior of the pod of FIG. 3.

### DETAILED DESCRIPTION OF THE PREFERRED EMBODIMENTS

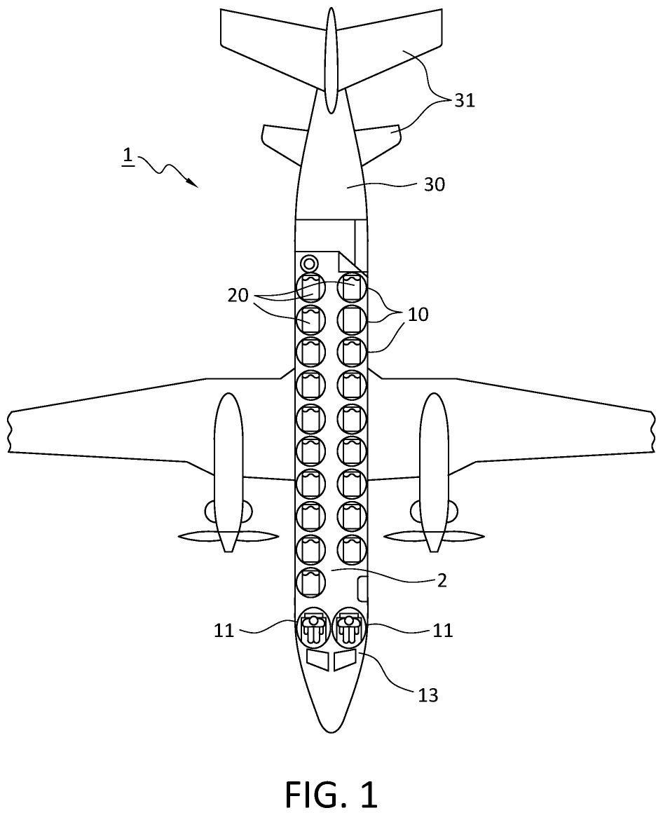

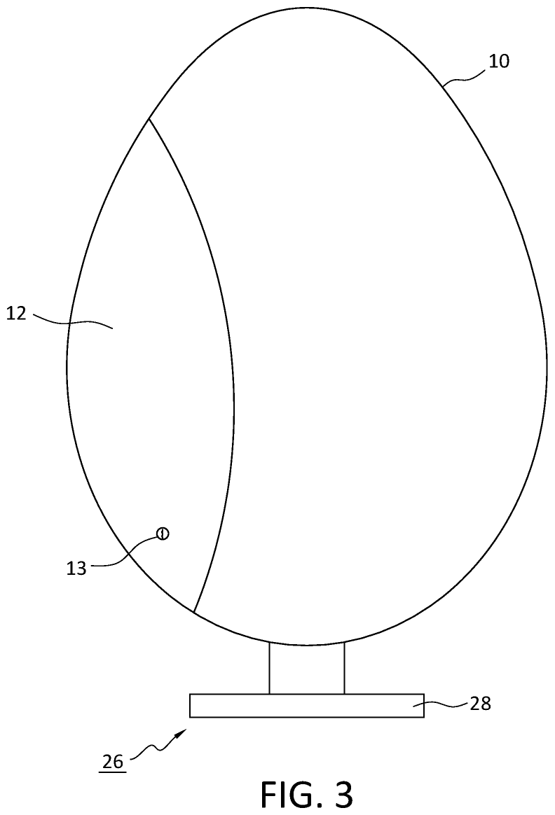

FIG. 1 shows an exemplary embodiment of a system for protecting occupants of a vehicle during a catastrophic event, such as a crash, collision, fire, or any other event that could endanger the occupants of the vehicle. The system of FIG. 1 includes a plurality of safety pods 10 that surround the occupants of the vehicle while in a seated position for normal, non-emergency, transport, and that may be ejected from the vehicle during a catastrophic event. In the case where the vehicle is an airplane 1, the safety pods 10 may each enclose a single seat or a row of seats 20, as shown in FIG. 1, with access to the safety pod 10 provided by an electrically operated door 12, shown in FIG. 3, that can remain open during non-emergency operation, but that is automatically closed when a catastrophic event is occurring or is imminent.

The pods 10 of the exemplary embodiment are illustrated as being ovoid in shape, although variations of the illustrated shape are within the scope of the invention. To provide protection for catastrophic events, the pods 10 are constructed of a material that is fire proof, waterproof, bomb proof, crash proof, and capable of withstanding any other physical or environmental hazards that might be expected during a catastrophic event. Examples of potentially suitable materials that are currently used in applications where strength, weight, and cost are considerations include, but are not limited to, acrylonitrile butadiene styrene (ABS), high-density polyethylene (HDPE), and polycarbonate (PC), which may further be treated, as necessary, heat and/or water resistant coatings or layers of material.

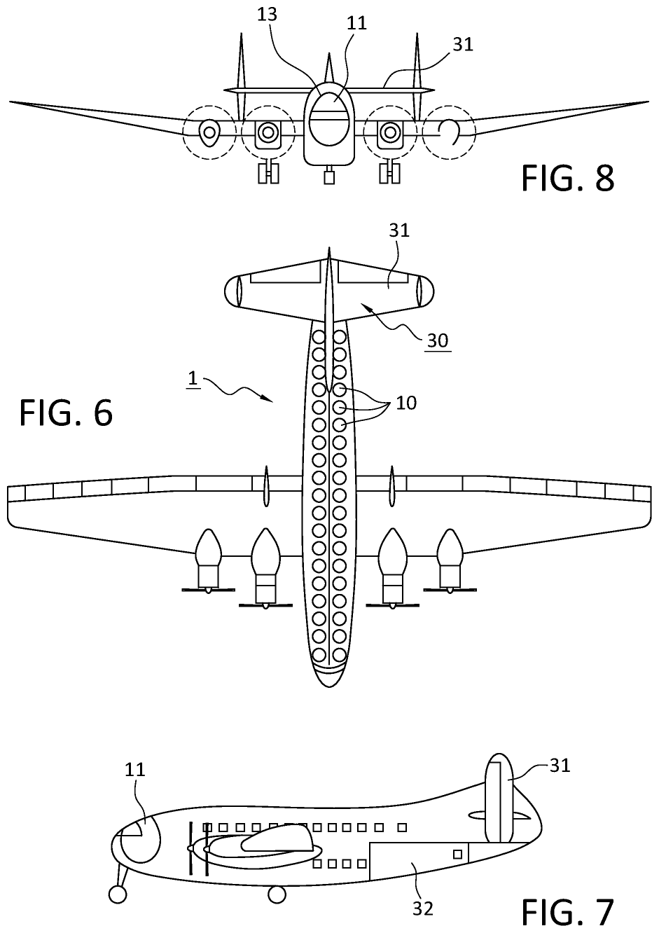

As shown in FIGS. 1 and 6, the airplane 1 is a passenger airliner with a single aisle 2 and pods 10 extending in columns along each side of the aisle. The pods 10 are schematically represented as circles, each surrounding a seat or row of seats 20, schematically represented as squares. Although only a single aisle 2 is shown, it will be appreciated that the invention may be applied to other airplane configurations, including airplanes with multiple aisles, cabins, and/or decks, and to jets as well as the illustrated two or four engine turboprop.

Also shown in FIG. 1 are crew safety pods 11 surrounding pilot and copilot seats in the cockpit 13 of the airplane. The crew safety pods 11 may be similar to the passenger pods, but with the access door repositioned to the front of the pods to provide ingress and egress and also to enable the pilot and copilot to view and manipulate aircraft controls in the manner to which they are accustomed. If necessary, multiple access doors can be provided for each crew safety pods 11.

The pods 10 are arranged to enable passengers to access their seats before and during flight, and to minimize inconvenience to the passenger(s) or flight attendants. Passengers can enter and exit the pods 10 through the respective doors 12 to move about the aircraft cabin, and flight attendants can interact with passengers to provide service items such as drinks and meals, or blankets, headphones, and the like, in the same manner as they would in a conventional aircraft with no pods. The presence of the safety pods 10 preferably should have no substantive effect on the passenger experience—until an catastrophic event occurs that puts the passengers at risk and/or that might necessitate ejection of the pods 10 from the aircraft 1.

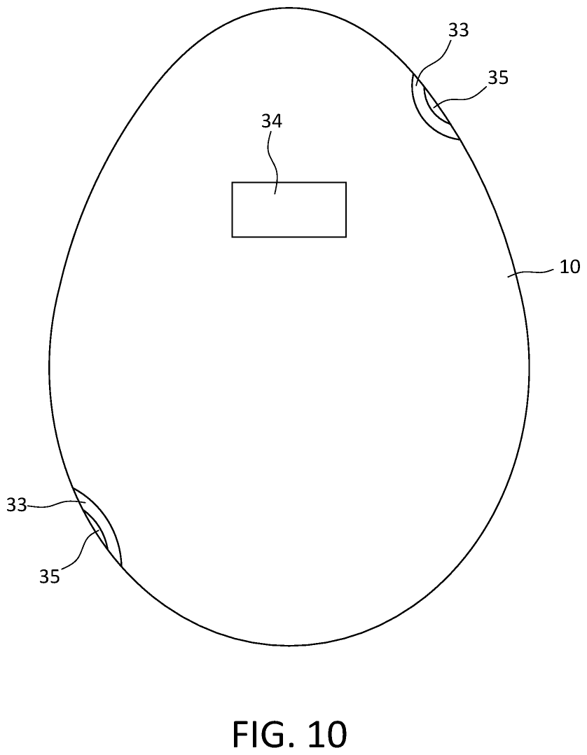

In the exemplary embodiment, pods 10 are pressurized and arranged to completely surround the respective seats or rows of seats 20 to provide complete protection of the occupants of the seats. For aircraft use, seals or gaskets (not shown) on the doors 12 maintain pressure inside the pod 10 when the door 12 is closed. During normal flight, the doors 12 are maintained in an open state so that passengers may exit the pods to move about the cabin or visit the restroom. In the event of an accident or event that requires ejection of the pods 10, the doors 12 are automatically closed to seal the pods. Door locks may also be provided, and may include a key 13A and cylinder lock arrangement 13 that permits manual release of the doors 12 when safe to do so, in the event that power is not available. In addition, doors 12 may be provided with windows or display screens 34, described below in connection with FIG. 10.

Although the pods 10 are designed to be sealed during ejection of the pods from the airplane, and to be open during non-emergency flight, there may be situations where closing and sealing of the pods 10 is advantageous even when there is no need for ejection of the pods from the airplane. Such situations may include, but are not limited to, loss of cabin pressure and the presence of smoke or hazardous fumes in the passenger cabin.

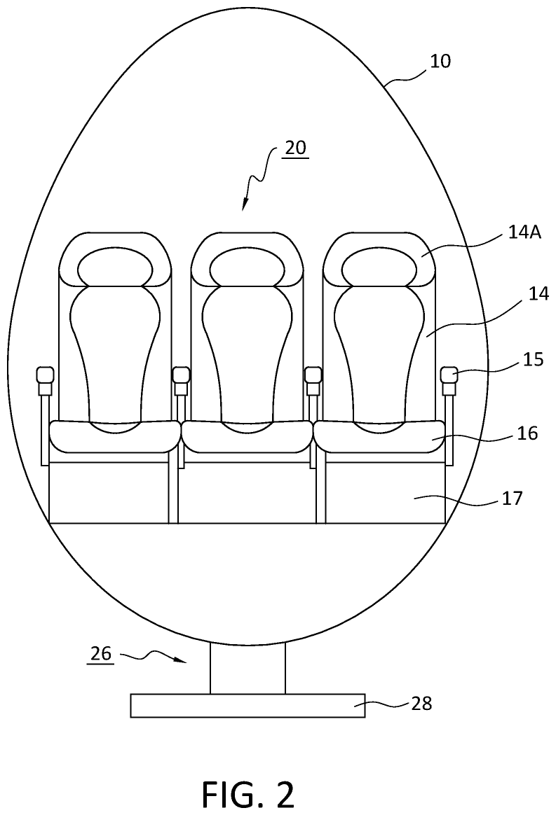

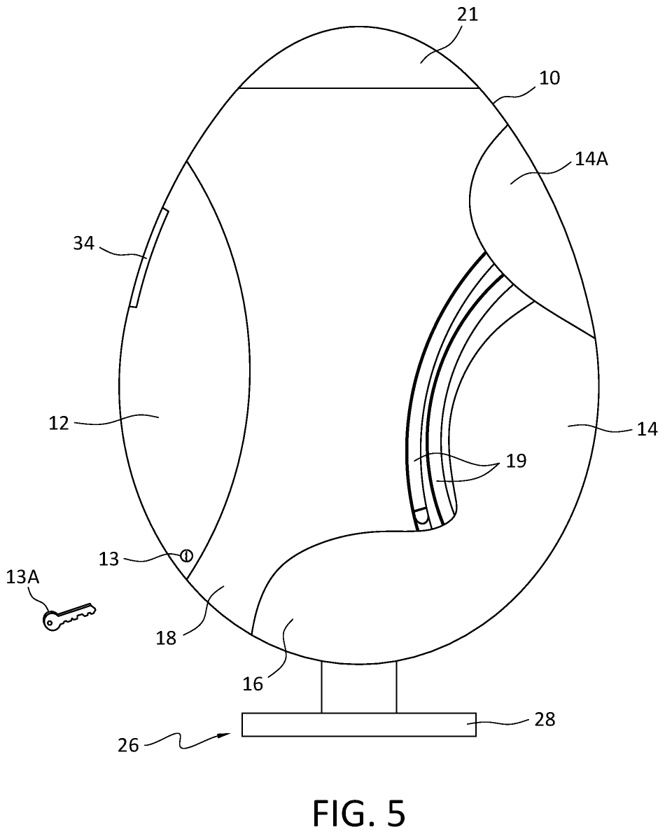

A possible seat configuration for three passengers is shown in FIG. 2. Each of the three seats shown in FIG. 3 includes a built-in cushioned back rest 14, padded arm rests 15, a padded seat 16, a storage space 17 below the seat, and space 18 in front of the seat for the occupant's legs (visible in FIG. 5), and. As illustrated, the row of seats 20 may be identical to a conventional passenger airliner's row of seats, including provision to adjust the positions of the backrest 14, headrest 14A, arm rests 15, and seat 16 to accommodate different size passengers and/or for passenger preferences and comfort. However, it is also possible to modify the seats to include additional padding, and to adjust the spacing or pitch of the seats to enable the seats to fit within the pod 10. As a result, those skilled in the art will appreciate that the invention is not to be limited to a particular seat configuration or number of included seats.

Instead of a conventional passenger airplane seatbelt, the respective seats in row 20 may be provided with a passive restraint system in the form of a five point safety harness 19 of the type shown in FIG. 5 and similar to t-shaped seat belt systems used in military jets, infant car seats, or amusement park roller coasters. The inside surface of the exterior structure of the pod 10 is preferably also padded for added safety in case of a failure of the passive restraint system.

Also as illustrated in FIG. 5, the top section 21 of the pod 10 may be detachable to serve as a parachute that is deployed after ejection of the pod 10 from an aircraft when the ejection occurs above a minimum height, as determined by an altitude sensor, and/or at a specified rate of descent. The top section/parachute 21 may be provided with suspension lines (not shown) so that, upon separation of the top section 21 from the occupied portion of the pod, the suspension lines will expand at a controlled rate, allowing the canopy to open fully to slow the pod's descent. The illustrated pod is preferably designed to survive impact if ejected from below the minimum height. For example, the minimum height may be 250 feet. As an alternative to use of the top section 21 of the pod 10 as a parachute, it is possible to include a conventional parachute that deploys from a compartment (not shown) at the top of the pod 10.

In addition to being constructed to enable occupants to survive a freefall of greater than 250 feet, the pod 10 is preferably constructed to protect the occupants from other expected hazards that may be present, depending on the type of vehicle, both during and after ejection. For example, as mentioned above, the pod 10 may be fire proof, water proof, bomb proof, and crash proof, and, if utilized in an airplane or watercraft, the pod should be capable of flotation in the event of ejection over water. In addition, an optional ventilation system of the pod 10 may include filters to prevent ingress of smoke or toxic fumes while still providing a source of breathable air.

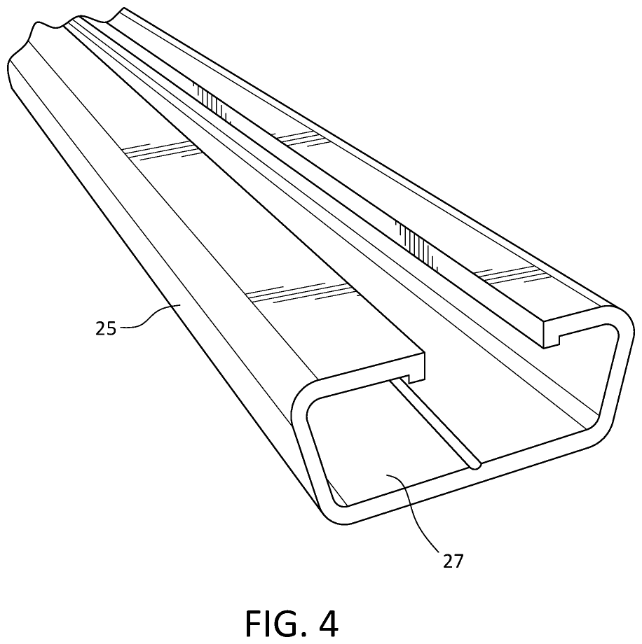

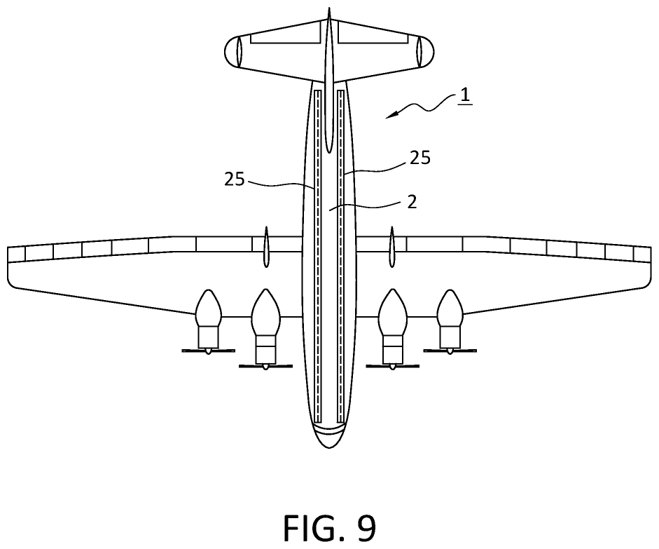

An exemplary arrangement for ejecting the pods 10 from an airplane is shown in FIGS. 1, 4, and 9. Each of the pods 10 is mounted on a track 25 such as the one shown in detail in FIG. 4, which extends along a length of the passenger cabin and cooperates with a t-shaped base 26 shown in FIGS. 3 and 5. As shown in FIG. 9, track 25 extends along the cabin floor on each side of aisle 2. Each of the respective horizontal portions 28 of t-shaped bases 25 is arranged to slidably fit within longitudinal passage 27 and move along the track 25 towards the rear of the airplane during ejection. The horizontal portions may be supported by roller bearings, frictionless bearing surfaces, an electromagnetic suspension, or other known means for ensuring that the pods 10 can slide towards the rear of the airplane during ejection. Those skilled in the art will appreciate that the configuration of the track 25, and the complementary base 26 extending from each pod 10, may be varied without departing from the scope of the invention. Any mounting arrangement that enables the pod to move towards the rear of the cabin may be employed.

The pods 10 will normally be latched or secured in place and prevented from movement during flight. The latching or securing mechanism (not shown) may be passive, for example a detent or a pin that breaks when a force is applied to the pod to propel it rearwardly along the track, or active, for example a solenoid that can be released when an ejection sequence is activated. The force that propels the pods towards the rear of the plane may be provided by a controlled explosion or pneumatic arrangement of the type used to eject the pilot in a military jet. Alternatively, a motor or electromagnetic propulsion may be used to propel the pods 10 along the track 25 towards the rear of the airplane

To enable ejection of a pod from the rear of the plane, the rear of the plane must be open. As shown in FIGS. 1 and 6, such an opening can be provided by constructing a rear or tail section 30 of the airplane 1, which may include the tail and/or rear stabilizers 31, to detach from the plane. Detachment can be accomplished by explosives, or releasing fasteners that normally secure the rear section 30 of the plane to the remainder of the fuselage or passenger cabin. Alternatively, as shown in FIG. 7, a hatch, door, or breakaway hull section 32 may be provided at the end of each track 25 to create an opening large enough to enable ejection of the pods 10 during a catastrophic event severe enough to require ejection. In case of an emergency landing, the pods 10 could be sealed but remain in place, with the real or tail section 30 left in place to enable control of the airplane 1 during the emergency landing.

The pods 11 for the pilot and copilot can also be mounted on track 25 for ejection with the pods 10, although this would require a mechanism for creating an opening at the rear of the cockpit 13 through which pods 11 can be propelled. Alternatively, it is also within the scope of the invention to provide an alternative path and system for ejection of the pilot and copilot pods 11, for example by constructing the cockpit 13 to break away from the airplane is a manner similar to the rear section of the airplane, as shown in FIGS. 7 and 8, thereby creating an opening for ejection of the pilot and copilot pods 11. The pilot and copilot pods may be replaced by a single pod containing two seats, and may further include instrumentation to enable monitoring and control of the airplane 1 when the pod is sealed.

FIG. 10 shows various additional features of one of the exemplary pods 10. These features are specifically designed for pods installed in an airplane or that might end up, after ejection, in remote areas or at sea. The additional features, as well as features such as the parachute arrangement shown in FIG. 5, may not be necessary in pods intended to be used in vehicles such as automobiles that are unlikely to crash in remote areas or to fall from a height of greater than 250 feet.

Illustrated are a pair of solar panel/battery units 33 to provide power for the pod, and the window or display screen 34. Display screen 34 and other electrical components may be powered by a solar panel or battery to enable occupants of the pod 10 to view surroundings of the pod when the pod is sealed and/or after ejection. In addition, various types of lights or beacons 35 may be provided, for example in one or both of the solar panel/battery units, either to enable the occupant to view surroundings at night, or to serve as a beacon to help rescuers locate the pod.

In addition, the pods may be provided with storage areas (now shown), in addition to the under-seat storage area 17 illustrated in FIG. 2, for a passenger's carry-on bags, as well as a first aid kit, flashlight, non-perishable food items, containers for water, and other emergency supplies. To accommodate carry-on luggage, a minimum size for the storage area would, by way of example and not limitation, be 20 inches wide, 17 inches long, and 11 inches tall.

Those skilled in the art will appreciate that, since the pod is sealed, a ventilation system (not shown) may need to be provided for situations in which the pod ends up at sea or in a hazardous environment and the door to the pod cannot be opened for an extended period. In addition, the pod may be provided with a heating and/or air conditioning unit (not shown).

In addition, those skilled in the art will appreciate that the dimensions of the pod will depend on the type of vehicle in which the pod is included. While the dimensions of each pod may be varied to accommodate different vehicles, the pods should at least be large enough to accommodate one or more seats, as illustrated in FIG. 2, without occupying more space than is allotted for seating arrangements in a conventional pod-less vehicle.

Finally, although exemplary embodiments of the invention have been described in connection with the appended drawings, it is anticipated that numerous variations of the exemplary safety system and safety pods will occur to those skilled in the art. For example, as explained above, the pod may be used in vehicles other than aircraft, such as buses, trains, space ships, armored personnel carriers, tanks, and automobiles.

For an automobile, the pod may be configured to take the place of a car seat of the type used to protect infants who are too young to be protected by airbags. For other vehicles, it is preferred to not provide a separate pod for infants, but to arrange an adult pod to also include infant restraints so as to ensure that an infant is not separated from its caregiver.

In the case of spacecraft, the pod may be designed to withstand re-entry into the earth's atmosphere, and may include such additional features as an oxygen generator and radiation shielding.

As a result, those skilled in the art will appreciate that the description of the exemplary embodiments is not intended to be limiting, and that modifications of the exemplary embodiments may be made without departing from the scope of the invention, which should be limited solely by the appended claims.

What is claimed is:

1. A system for protecting a passenger of a vehicle from catastrophic events that threaten death or injury to the passenger, comprising:
a safety pod including:
a safety pod housing;
a seating arrangement within the housing for accommodating at least one said passenger; and
a door for enabling ingress and egress from the pod,
a bracket for securing the safety pod housing in the vehicle; and
a mechanism for releasing the bracket and ejecting the safety housing from the vehicle,
wherein the door is closed to form a sealed chamber surrounding the seating arrangement and seated passenger during and after ejection of the pod from the vehicle when the catastrophic event occurs or is imminent.

2. A system as claimed in claim 1, wherein the safety pod is ovoid in shape.

3. A system as claimed in claim 1, wherein the door is electrical operated and includes a manual release.

4. A system as claimed in claim 1, wherein the safety pod is mounted on a track, latched in place during operation of the vehicle, and movable along the track to an ejection opening in the vehicle when the catastrophic event occurs or is imminent.

5. A system as claimed in claim 4, wherein the safety pod configured to be is propelled towards the opening by an explosion, a motor, or a pneumatic or electromagnetic actuator.

6. A system as claimed in claim 4, wherein the vehicle includes a detachable section that detaches when the catastrophic event occurs or is imminent to form the ejection opening.

7. A system as claimed in claim 5, wherein the vehicle is an airplane, and the detachable section includes a tail section of the airplane situated to the rear of the passenger cabin.

8. A system as claimed in claim 1, wherein the vehicle is an airplane and the safety pod is configured to enclose at least one airline seat that includes a seat cushion, seat back, at least one armrest, and space for legs of the passenger.

9. A system as claimed in claim 8, wherein the safety pod is configured to enclose a row of airline seats.

10. A system as claimed in claim 9, wherein the safety pod includes an electrically operated door that opens to an aisle of the airplane to enable passengers to enter and leave the safety pod, and to receive service items from a crew of the airplane, and wherein the door closes to seal the pod when the catastrophic event occurs or is imminent.

11. A system as claimed in claim 1, wherein the vehicle is an airplane, and the system further includes at least one safety pod situated in a cockpit of the airplane to protect a pilot and/or copilot of the airplane.

12. A safety pod, comprising:
a safety pod housing;
a seating arrangement within the housing for accommodating at least one said passenger; and
a door for enabling ingress and egress from the pod,
wherein the door is closed to form a sealed chamber surrounding the seating arrangement and seated passenger during and after ejection of the pod from the vehicle when the catastrophic event occurs or is imminent

13. A safety pod as claimed in claim 12, wherein the safety pod is ovoid in shape.

14. A system as claimed in claim 12, wherein the safety pod is arranged to be ejected from the vehicle when the catastrophic event occurs or is imminent.

15. A system as claimed in claim 14, wherein the safety pod is mounted on a track, latched in place during operation of the vehicle, and movable along the track to an ejection opening in the vehicle when the catastrophic event occurs or is imminent.

16. A system as claimed in claim 15, wherein the safety pod includes a base having a t-shape, wherein horizontally extending sections of the base fit within and are slidable along a horizontally extending channel in the track.

17. A system as claimed in claim 12, wherein the vehicle is an airplane, and the safety pod is configured to enclose at least one airline seat that includes a seat cushion, seat back, at least one armrest, and space for legs of the passenger.

18. A system as claimed in claim 16, wherein the safety pod is configured to enclose a row of airline seats.

19. A system as claimed in claim 16, wherein the safety pod includes an electrically operated door that opens to an aisle of the airplane to enable passengers to enter and leave the safety pod, and to receive service items from a crew of the airplane, and wherein the door closes to seal the pod when the catastrophic event occurs or is imminent.

20. A system as claimed in claim 16, wherein a top section of the safety pod is detachable and connected to the safety pod by suspension lines to form a parachute.

21. A system as claimed in claim 19, wherein the top section of the safety pod is configured to detach from the safety pod following ejection at a predetermined altitude or rate of descent.
